(19) United States
(12) Patent Application Publication
(10) Pub. No.: US 2022/0391900 A1
(43) Pub. Date: Dec. 8, 2022

(54) TEE-BASED MINING POOLS FOR POW-CRYPTOCURRENCIES

(71) Applicant: NEC Laboratories Europe GmbH, Heidelberg (DE)

(72) Inventors: Karl Wuest, Zurich (CH); Kari Kostiainen, Zurich (CH); Ghassan Karame, Heidelberg (DE); Srdjan Capkun, Zurich (CH)

(21) Appl. No.: 17/770,059

(22) PCT Filed: Sep. 25, 2020
(86) PCT No.: PCT/EP2020/076931

§ 371 Date: Apr. 19, 2022

(30) Foreign Application Priority Data
Apr. 23, 2020 (EP) 20171003.5

(51) Int. Cl. G06Q 20/40; H04L 9/00; G06Q 20/22

(52) U.S. Cl. CPC G06Q 20/401; H04L 9/50; G06Q 20/223

(57) ABSTRACT

A method for operating a mining pool includes running, by a mining pool operator, a blockchain node and at least one enclave. The blockchain node is connected to the enclave as well as to a blockchain P2P network and to a publicly available site. The method further includes checking, by the blockchain node, validity of incoming blocks and transactions received from the blockchain P2P network, and forwarding information on the received blocks and transactions to the at least one enclave. The method further includes creating, by the at least one enclave, a state transparency log and inserting the block and transaction information received from the blockchain node into the state transparency log, and signing, by the at least one enclave, the state transparency log and publishing the state transparency log at the publicly available site.

### CROSS REFERENCE TO RELATED APPLICATIONS

This application is a U.S. National Phase application under 35 U.S.C. § 371 of International Application No. PCT/EP2020/076931, filed on Sep. 25, 2020, and claims benefit to European Patent Application No. EP 20171003.5, filed on Apr. 23, 2020. The International Application was published in English on Oct. 28, 2021, as WO 2021/213691 A1 under PCT Article 21(2).

### FIELD

The present invention generally relates to a method for operating a mining pool. Furthermore, the invention relates to a mining pool operation system run by a mining pool operator.

### BACKGROUND

When Bitcoin was created (cf. Satoshi Nakamoto. Bitcoin: A peer-to-peer electronic cash system. 2008), its security was based on the assumption that a majority of the mining power is under the control of honest entities and that this mining power is distributed among many parties (exemplified by the analogy “one-CPU-one-vote”).

Since then, the overall mining power in the Bitcoin network has increased steadily. This is partially due to advances in mining hardware (e.g. more efficient ASICs), but also due to a larger number of miners. Because of this, the variance for the duration between payouts for a single miner has increased to an extend that payouts have become extremely irregular. The same development has happened to other Proof-of-Work (PoW) cryptocurrencies such as Ethereum (cf. Gavin Wood. Ethereum: A secure decentralized generalized transaction ledger. Ethereum project yellow paper, 2014).

This has led to the creation of large mining pools, in which many miners contribute their mining power and all block rewards are split among the participants dependent on their contributed hash power. This hash power is measured based on submitting so called shares that present solutions to the Proof-of-Work puzzle given a lower difficulty. By pooling their mining power, miners get much more regular but smaller payouts and therefore reduce risk for single miners.

While participating in a mining pool is arguably beneficial for miners, it also leads to centralization in PoW cryptocurrencies since very few mining pools together control a majority of the mining power (cf. Arthur Gervais, Ghassan O Karame, Vedran Capkun, and Srdjan Capkun. Is bitcoin a decentralized currency? IEEE security & privacy, 12(3):54-60, 2014). Centralization is not an issue per-se, but it can become problematic if it substantially changes the underlying trust assumptions.

This change of trust assumptions is the case in mining pools; most pools are operated by a centralized pool operator that makes decisions such as which transactions are included, which branch is chosen in case of a fork, and who is in charge of correctly paying rewards to the individual miners based on their submitted shares. Thus, operators of centralized pools hold enormous power, as only four mining pools together provide the majority of the hash power in Bitcoin. This power could be misused for a plethora of attacks including selfish mining (cf. Ittay Eyal and Emin Gün Sirer. Majority is not enough: Bitcoin mining is vulnerable. In International Conference on Financial Cryptography and Data Security, pages 436-454. Springer, 2014) and double spending (cf. Arthur Gervais, Ghassan O Karame, Karl Wüst, Vasileios Glykantzis, Hubert Ritzdorf, and Srdjan Capkun. On the security and performance of proof of work blockchains. In Proceedings of the 2016 ACM SIGSAC conference on computer and communications security, pages 3-16. ACM, 2016) and requires participants to trust a small set of pool operators instead of the majority of the mining power. It also changes the trust assumptions for individual miners participating in a pool, as they need to trust the operators for correctly paying out the rewards.

The original assumptions have therefore changed. It is no longer the case that a large set of miners with control over their computing power need to be trusted. Instead a small set of mining pool providers now needs to be trusted since they control most of the mining power.

Existing proposals such as P2Pool (cf. Bitcoin Wild-P2Pool. https://en.bitcoin.it/wiki/P2Pool, 2019) and SmartPool (cf. Loi Luu, Yaron Velner, Jason Teutsch, and Prateek Saxena. Smartpool: Practical decentralized pooled mining. In 26th {USENIX} Security Symposium ({USENIX} Security 17), pages 1409-1426, 2017) focus on decentralization to solve this issue. However, centralized solutions have proven to be more efficient and more profitable, are easier to use, and thus require less effort from the individual miners, which prevented profit-oriented miners from switching to such decentralized pools.

Even proposals such as getblocktemplate (cf., e.g., Bitcoin Wiki-getblocktemplate. https://en.bitcoin.it/wiki/Getblocktemplate, 2019) that do not try to completely decentralize mining pools, but give miners the option to assemble block headers themselves, are not used much in practice, since it is easier for miners to simply run a protocol such as Stratum where they receive headers from the pool operator and only solve the proof-of-work.

### SUMMARY

In an embodiment, the present disclosure provides a method for operating a mining pool. The method includes running, by a mining pool operator, a blockchain node and at least one enclave. The blockchain node is connected to the enclave as well as to a blockchain P2P network and to a publicly available site. The method further includes checking, by the blockchain node, validity of incoming blocks and transactions received from the blockchain P2P network, and forwarding information on the received blocks and transactions to the at least one enclave. The method further includes creating, by the at least one enclave, a state transparency log and inserting the block and transaction information received from the blockchain node into the state transparency log, and signing, by the at least one enclave, the state transparency log and publishing the state transparency log at the publicly available site.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a diagram schematically illustrating a system model of a TEE-based mining pool in accordance with an embodiment of the present invention, and

FIG. 2 is a sequence diagram schematically illustrating an overview of the flow of messages in a system of FIG. 1 in accordance with an embodiment of the present invention.

### DETAILED DESCRIPTION

Embodiments of the present invention improve and further develop a method for operating a mining pool and a mining pool operation system in a way that ensures that the pool operator does not use the mining pool for attacks and that provides trustability for mining rewards.

In accordance with embodiments of the invention, the aforementioned improvements can be accomplished by a method for operating a mining pool, wherein the method comprises running, by a mining pool operator, a blockchain node and at least one enclave, wherein the blockchain node is connected to the enclave as well as to a blockchain P2P and to a publicly available site; checking, by the blockchain node, the validity of incoming blocks and transactions received from the blockchain P2P network and forwarding information on the received blocks and transactions to the at least one enclave; creating, by the at least one enclave, a state transparency log and inserting the block and transaction information received from the blockchain node into the state transparency log; and signing, by the at least one enclave, the state transparency log and publishing the state transparency log at the publicly available site.

Furthermore, embodiments of the present invention provide a mining pool operation system run by a mining pool operator, wherein the system comprises a blockchain node, and at least one enclave, wherein the blockchain node is connected to the enclave as well as to a blockchain P2P network and to a publicly available site, wherein the blockchain node is configured to check the validity of incoming blocks and transactions received from the blockchain P2P network and to forward information on the received blocks and transactions to the at least one enclave, wherein the at least one enclave is configured to create a state transparency log, to insert the block and transaction information received from the blockchain node into the state transparency log, and to sign the state transparency log, and wherein the blockchain node is further configured to publish the signed state transparency log at the publicly available site.

Embodiments of the present invention can mitigate the trust issues arising from having few centralized mining pools that govern the operation of permissionless blockchains. In this context, it has been recognized that centralization is not an issue per-se, but it can become problematic if it substantially changes the underlying trust assumptions. Furthermore, it has been recognized that decentralization is only a means to an end and not the actual objective. Embodiments of the present invention remove trust requirements from centralized pools instead of decentralizing them, thereby keeping the benefits of centralized mining pools without needing to trust mining pool operators. As a solution, embodiments of the present invention leverage enclaves, hereinafter sometimes also referred to as trusted execution environments (TEEs), to ensure that pool operators are running the correct code for their mining pool operation. Specifically, embodiments of the invention provide for the creation of transparency log that is signed by an enclave (such as, e.g., an Intel SGX enclave) for each mining pool to prevent abuse. The system, according to an embodiment of the invention, preserves the advantages of centralized mining pools, low variance for payout intervals and high operating efficiency, while ensuring that the pool operator does not use the mining pool for attacks and provides fairness for mining rewards.

According to an embodiment, it may be provided that the block and transaction information inserted into the state transparency log include the block headers of the received blocks, the hashes of the transactions included in the received blocks and an additional information about the transactions included in the received blocks. The additional information about the transactions inserted into the state transparency log may depend on rules defined in the enclave code of the enclave, in particular inclusion rules that the enclave should apply.

According to an embodiment it may be provided that the enclave sends work packets to the miners through a secure channel and receives in return shares from the miners once they find partial PoWs. The enclave may check the received shares and use them to create payment transactions for the miners (7) based on a reward scheme. The most basic reward payment scheme to be used could be the Pay Per Share that offers an instant, guaranteed payout for each share that is solved by a miner. On the other hand, Equalized Shared Maximum Pay Per Share requires that payments are distributed equally among all miners in the pool. Recent Shared Maximum Pay Per Share, on the other hand, gives priority to the most recent Bitcoin workers. A different approach is that offered by the Proportional scheme which proposes a proportional distribution of the reward among all workers when a block is found—based on the number of shares they have each found. A well-known variation of this technique that could be used is the Pay Per Last N Shares (PPLNS, as described e.g., in Meni Rosenfeld. Analysis of bitcoin pooled mining reward systems. arXiv preprint arXiv:1112.4980, 2011), where rather than counting the number of shares in the round, only the last submitted correct N shares are taken into account.

With respect to an enhanced transparency for the miners with regard to the payment transactions, it may be provided that the blockchain node periodically receives the payment transactions created by the enclave and broadcasts the received payment transactions to the blockchain P2P network.

According to an embodiment, it may be provided that the enclave, upon receiving a valid block from a miner, includes its hash into the state transparency log and forwards the valid block and the state transparency log to the blockchain node. The blockchain node may then broadcast the valid block to the blockchain P2P network and update the state transparency log at the publicly available site.

According to an embodiment the mining pool operator may, when performing attestation with the enclave, publish the attestation statement on the publicly available site.

According to an embodiment, it may be provided that a private key used by the enclave for signing the state transparency log is newly created at each restart of the enclave. In other words, the key only exists during the enclave's lifetime, i.e. is not persistent over enclave restarts, which provides protection against rollback and forking attacks.

According to an embodiment, instead of running only a single enclave, the mining pool operator may run two enclaves, where the two enclaves are responsible for different parts of the operation, thereby providing the advantage of parallelization of different system components. It may be provided that the enclaves perform mutual attestation for each other during which the enclaves exchange keys, and establish a secure channel between each other. Specifically, a first one of the two enclaves—hereinafter sometimes denoted logging enclave—may interact with the blockchain node, while a second one of the two enclaves—hereinafter sometimes denoted distribution enclave—may interact with miners connecting to the mining pool.

According to embodiments of the invention, it may be provided that, when the mining operator starts his machine, the two enclaves are started and create a keypair, which only exists during the enclaves lifetime. Is already mentioned above, the enclaves may then perform mutual attestation for each other during which they exchange keys, and establish a secure channel. When miners connect to the mining pool, they first perform attestation of those enclaves. Optionally the mining pool server may perform attestation with the logging enclave and publish the attestation statement on the state transparency log website. The blockchain node of the mining pool operator may check the validity of incoming transactions and blocks. After these validity checks, the mining pool server forwards block headers together with the hashes of transactions included in the block and information about new transactions (in the present disclosure sometimes denoted ‘transaction summaries’), to the logging enclave. The logging enclave may include all received block and transaction information in the state transparency log, sign it and make it public.

There are several ways how to design and further develop the teaching of the present invention in an advantageous way. To this end it is to be referred to the dependent claims on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will be explained.

Although embodiments of the present invention can be applied in any blockchain system and, in particular, for any cryptocurrency with block mining, the proposed scheme will be described hereinafter in connection with Bitcoin as the most notable cryptocurrency with Proof-of-work (PoW) mining. Furthermore, reference will be made to Intel SGX the most promising trusted execution environment that might be used in the deployment of embodiments of the invention. As will be appreciated by those skilled in the art, however, other trusted execution environments with similar capabilities may be deployed likewise.

Generally, Bitcoin enables its users to perform mutual payments by issuing transactions that are connected to specific addresses. In a regular Bitcoin transaction, bitcoins (BTC) are transferred from one or more input addresses to one or more output addresses. These addresses actually indicate public keys. Only a user that knows the corresponding private key of that public-private key pair may spend the bitcoin connected to a specific public address.

When a user wants to perform a payment she creates a transaction with all the needed parameters, such as input and output addresses along with the amount of bitcoin that is to be transferred. Subsequently, the transaction is signed and sent to all nodes using the P2P network. Nodes across the network collect transactions and form blocks. These blocks are generated by a special type of nodes (clients) called miners that have to solve a hash-based proof-of-work task. The first one to mine the block broadcasts it to all other nodes for verification of the block correctness and inclusion to the blockchain. Bitcoin is designed in a way that all nodes in the system have to verify the transactions and blocks received from the network.

The current difficulty level of mining valid blocks is so prohibitively high that it reduces the incentives for miners to operate alone. Joining a mining pool is an attractive option to receive a portion of the Bitcoin block reward on a consistent basis. Namely, mining pools offer a way for miners to contribute their resources to generate a block and to split the reward between all the pool members following a certain reward payment scheme. Shares of the reward are assigned by the mining pool to its members (referred to as miners or workers) who presents valid proof-of-work. In more detail, a mining pool sets target between 1 and the blockchain's target difficulty (denoted in the sequel as pool target level). Subsequently, a share is assigned to those workers that provide a block header that scores a difficulty level between the pools difficulty level and the currency's difficulty level. The main purpose of these block headers is to show that the worker is contributing with a certain amount of processing power.

While consolidating their mining power in mining pools benefits miners (in terms of sharing rewards proportionally to their mining power within the pool and receiving regular payouts), mining pools have become very large, to the extent that four mining pools together currently control a majority of the hashing power. This means that Bitcoin, designed to work without trusted third parties, has become more and more centralized and is controlled by a few semi-trusted parties. While centralization is not an issue per-se, it can become problematic if it substantially changes the underlying trust assumptions, which is the case here.

Most pools are operated by a centralized pool operator that decides which transactions are included, which branch is chosen in case of a fork, and who is in charge of correctly paying rewards to the individual miners based on their submitted shares. Pool operators are therefore semi-trusted entities that hold enormous power, which could be misused for a plethora of attacks including selfish mining and double spending. It also changes the trust assumptions for individual miners participating in a pool, as they need to trust the operators for correctly paying out the rewards.

While several potential solutions exist, all of them try to solve the problem by increasing decentralization. The main drawback of all of these solutions is that they require additional effort from miners, which increases costs. As a result, all of these schemes are rarely used in practice.

Embodiments of the present invention are based on the comprehension that decentralization is only a means to an end and not the actual goal. The goal instead is to go back to the original trust assumptions: That the majority of the miners themselves, instead of the mining pools, are honest. Embodiments of the invention therefore aim at keeping the benefits of centralized mining pools without needing to trust mining pool operators.

A successful solution that keeps the benefits of centralized mining pools while removing their downsides should ideally have the following properties:

Branch Selection. The system needs to ensure correct branch selection, i.e. it needs to ensure that the operator lets miners mine on top of the longest chain and that blocks found by the mining pool are not kept secret.

Censorship Resistance. The system should ensure that censorship of arbitrary transactions can be prevented or detected.

Reward Distribution. The system should ensure fair distribution of mining rewards, i.e. every miner should receive a share of the pool's mining reward approximately proportional to his share of the mining power within the pool.

Performance. The system has to work efficiently, i.e. it should not be significantly more costly than existing centralized mining pools to ensure profitability for the miners.

Least Effort. The system should require the least possible amount of effort from the miners to participate.

Embodiments of the present invention leverage trusted execution environments (TEEs) to ensure that pool operators are running the correct code for their mining pool operation, i.e. code that behaves according to the protocol and does not mount attacks on the blockchain. In particular, the rewards sharing component may be included in a trusted execution environment to ensure rewards being distributed fairly to all participating miners. This approach is intended to preserve the advantages of centralized mining pools, i.e. low variance for payout intervals and high operating efficiency, while making it more robust against attacks. For example, the pool operator should be prevented from mounting block withholding attacks and fairness for mining rewards should be guaranteed.

In a system according to embodiments of the invention, the following three types of entities may be implemented:

Mining Pool Operators: Mining pool operators run mining pools, i.e. they create block candidates, distribute work to individual miners, and distribute the fees to the miners. It is assumed that mining pool operators are untrusted but rational. It is also assumed that mining pool operators can run code in a trusted execution environment (TEE) such as Intel SGX, which is trusted for integrity.

Miners: Miners are the entities running the mining hardware. They receive work from mining pool operators and try to solve the proof-of-work puzzles. It is assumed that a majority of miners are honest, but want to reduce their effort as much as possible, i.e. they do not take special precautions to proactively prevent dishonest behavior. In connection with their honest behavior, it is assumed that a majority of the miners will take measures if they notice misbehavior, e.g. they will switch to a different mining pool, if they notice misbehavior of their mining pool operator. The assumption that a majority of miners is honest is one of the basic assumptions of proof-of-work blockchains and thus a minimal requirement for their security.

Other Blockchain Participants: Other participants in the blockchain ecosystem that are e.g. running blockchain clients are interested in the correct behavior of miners and mining pools, e.g. want to prevent attacks and censorship. Because of this, they have an incentive to alert other parties (e.g. miners) if they notice misbehavior. It should be noted that mining pool operators other miners can, in addition to their other role, also fall into this category. For example, a mining pool operator might have an interest to make sure that other mining pools behave honestly, independent of their own behavior, or a miner may want to monitor the blockchain from a separate node, even if they do not want to connect their mining pool infrastructure to the network for simplicity.

A simple strawman solution to the problems outlined above would be to simply move the whole mining pool operator code into a trusted execution environment (TEE) and have individual miners attest that TEE. However, this presents multiple issues. First, moving the full operating node into a TEE would create a large trusted computing base (TCB), which is un-desirable, because it offers a large attack surface. Second, current TEEs, such as Intel SGX, are restricted to a low amount of memory, which is not sufficient for the full operating node. Finally, simply moving the software into a trusted execution environment is not enough to prevent attacks, since many (e.g. block withholding attacks) can be simply mounted by controlling the network connection and selectively blocking communication.

Based on the requirements outlined about, this presents the following challenges:

Branch Selection. A solution should ensure correct branch selection, i.e. it should ensure that the operator actually has miners mine on top of the longest chain. Since the operator fully controls the network connections of the enclave, he can arbitrarily block messages and therefore trick an enclave into believing that an alternative fork is currently the longest chain. Therefore, a mechanism needs to be provided that adds additional communication to ensure correct branch selection.

Censorship Resistance. Ideally, it should be ensured that a malicious mining pool operator cannot arbitrarily censor transactions. Similar to the branch selection problem, this requires the mining pool enclave to receive complete information. This is easily solvable by allowing miners to create their own block candidates, similar to getblocktemplate (cf. Luke Dashjr. getblocktemplate—Fundamentals, 2012), BetterHash (cf. Matt Corallo. BetterHash Mining Protocol(s), 2018), or Stratum (cf. Pavel Moravec, Jan Capek, and Matt Corallo. Stratum V2 Specification, 2019). However, this is not compatible with the assumption that miners are honest but lazy and this option would likely almost never be used in practice.

Reward Distribution. The distribution of the mining rewards to the miners should be fair, i.e. each miner should receive an amount proportional to their contributed work. If the operator software inside the enclave distributes rewards fairly based on the received PoW shares, the operator can only block the enclave from receiving shares. However this can be mitigated by providing signed receipts: If miners receive a receipt from the enclave for each submitted share, the operator can at most block one share from being successfully submitted, and therefore counted for the reward distribution, before the miner notices an attack and can switch to another mining pool. If the required puzzle difficulty is low enough, this ensures that each miner receives a reward proportional to the contributed work.

Performance. The system has to work efficiently, i.e. it should not be significantly more costly than existing centralized mining pools to ensure profitability for the miners. Since current TEEs, such as Intel SGX, are restricted to a low amount of memory, it is important to carefully identify critical parts of the software that need to run inside the enclave, and parts that can run outside of the enclave, and ensure that this can be done within the boundaries without adding significant performance overhead.

Least Effort. The system cannot require additional effort from the miners to participate. The main challenge here is to ensure the other requirements without minimal increase of the effort required from the miners. For example, the system should not require miners to assemble their own blocks.

Embodiments of the present invention provide a method for operating a mining pool as well as a mining pool operation system that solve the above challenges efficiently and practically. In detail, embodiments address the individual challenges as follows:

Reward Distribution. The easiest challenge to solve is the fair distribution of rewards. The main potential for mining pools to cheat miners is by miscounting shares. A mining pool operator can either not count some shares from a miner or he can add additional imaginary shares that he attributes to his own mining power to increase his own share and decrease that of other miners. The first case is easily detectable by the affected miner, albeit only once he is supposed to receive payment, by which time he may have already wasted a significant amount of mining power. The second case is hard to detect if the share of the operator's mining power is only inflated by a low amount (e.g. from 10% to 11%) which does not heavily affect the revenue of individual miners in the pool but noticeably benefits the mining pool operator.

Both of these potential issues can easily be solved without affecting the effort for miners if the component of the mining pool responsible for counting the shares resides in a TEE and issues signed receipts for every received valid share. This reduces the first issue to at most wasting a miners resources for the duration needed to create one share, since a miner quickly notices that an operator blocked an enclave from receiving his share (since the miner does not receive a receipt). For each miner, at most one share will not be counted (for the whole duration of the mining operation) which guarantees that shares will be counted roughly equal to the miner's percentage of the mining power. Similarly, the second problem is solved, since a mining pool operator can no longer forge invalid shares to inflate his numbers, as the enclave will only accept valid shares.

This ensures that shares are counted correctly and therefore, that every miner will get paid fairly or nobody gets paid (including the mining pool), if the mining pool operator takes the enclave offline. Under the assumption that mining pool operators are rational, this therefore suffices to ensure fair payments. Since this approach guarantees correct counting of the shares independent of the reward scheme, it can be used with any of them.

Branch Selection and Censorship Resistance. The main challenge is to make the pool resistant to attacks and censorship from the pool operator. Existing solutions already provide options to ensure correct branch selection and censorship resistance, for example the option for miners to create their own block candidates]. In addition, miners could directly forward mined blocks with a full proof-of-work to the P2P network to ensure that the pool operator cannot keep blocks secret. In theory, these options solve the mentioned problems, since miners can make sure that the block template correctly points to the head of the main chain and they can decide which transactions they include. However, in practice these options are rarely used, since they require effort.

While these options can be kept in systems of the present invention, they are unlikely to be used in practice (since they require additional effort from the miners) and thus a respective system cannot rely on them if the requirement of least effort shall be fulfilled. Therefore, embodiments of the present invention provide a system that is configured to work as desired if miners simply receive work instances from the mining pool operator.

According to embodiments of the invention, the mining pool operator is required to make a log called state transparency log publicly available, e.g. on a publicly accessible website. This state transparency log may consist of a list of blocks and transactions that were received by the enclave implemented at the mining pool operator, as well as a hashchain of these entries, signed by the enclave.

According to an embodiment, once the enclave receives a transaction or block from the operator (including blocks mined by the mining pool), it may respond with a hash of the concatenation of the previous hashchain value, a times-tamp, and the hash of the received item, as well as a signature on this hashchain value. The operator may then publish a list of included transactions and blocks together with the proof (i.e. hashchain and signature) that the enclave received them.

Any party in the blockchain network can then monitor this list and alert miners or other parties to potential misbehavior, e.g. if blocks have been propagated through the network but do not show up on this list, if transactions regularly are missing from the list, or if the list appears not to be updated for a significant amount of time (e.g. several minutes).

While this does not completely remove the potential for censorship or mining on alternative branches, it makes malicious behavior quickly detectable and provides strong evidence for it. The majority of miners, who are assumed to be honest, will then switch to other pools once they notice such behavior. Since it is in the general interest of most parties in the blockchain system (e.g. regular nodes or competing mining pools) to ensure correct behavior of mining pools, it is highly likely that miners will be alerted to misbehavior if such is noticed.

In principle, the state transparency log is very similar to a blockchain and in fact, much of the information visible in this log, is also visible in the blocks mined by the mining pool. However, there is a crucial difference in the granularity of the data and the speed at which it becomes visible. For example, from the blocks released by the mining pool (and knowledge of other blocks in the network), double spending attacks are detectable once the mining pool releases a privately mined chain. With the state transparency log in accordance with embodiments of the invention, such an attack would become apparent once the mining pool operator withholds blocks from the enclave even for a short amount of time, since the blocks would not show up in the log. This means that with a state transparency log, such attacks become detectable shortly after such an attack starts and can be prevented, while by considering only information in the mined blocks, it only becomes detectable after the fact.

Similarly, censorship can be detected much faster, since the contents of the mempool of the mining pool can be determined at any point in time. E.g. if a client sends a transaction to the mining pool, he (and others, if the transaction has propagated through the network) can immediately see, if the transaction is not forwarded to the enclave, because it will not show up in the log. In contrast, if only information in mined blocks is considered, this will only potentially be noticed after some blocks have been mined by the mining pool and even then it may be difficult to determine if a transaction was censored or not included because other transactions in the mempool took preference because they arrived earlier at the mining pool.

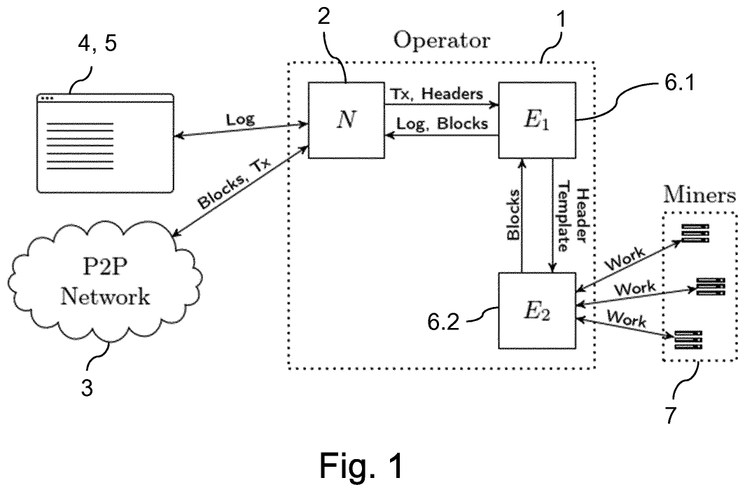

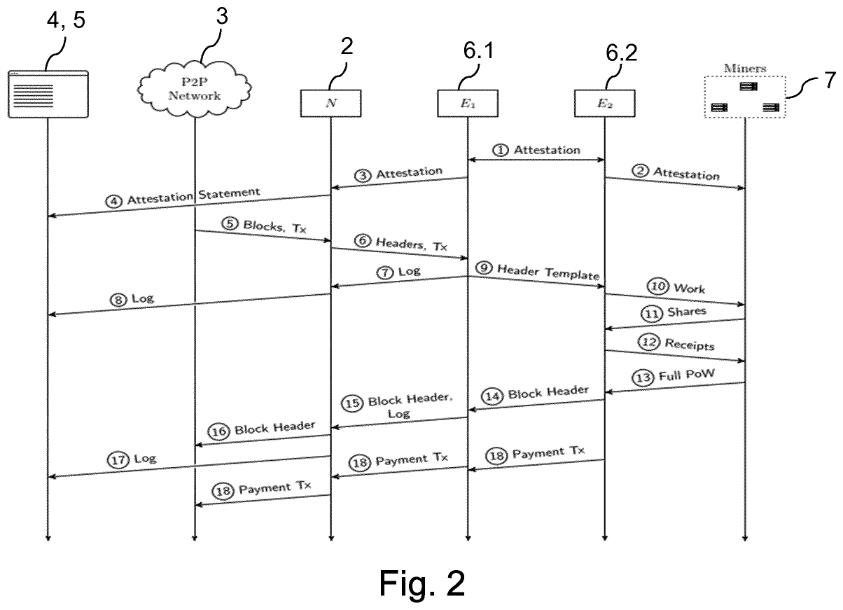

According to the embodiment illustrated in FIGS. 1 and 2, the mining pool operator 1 (hereinafter simply denoted ‘operator’) runs a node 2 (denoted ‘N’ in FIGS. 1 and 2) that is modified blockchain node and that is connected to the blockchain P2P network 3 as well as to a publicly available site 4, e.g. a website of a webserver 5. This site 4 is used for publishing a state transparency log, as will be described in more detail below.

The operator 1 can run either one or two enclaves 6. In the following, and as shown in the embodiment of FIGS. 1 and 2, we describe the system will be described with two enclaves 6.1, 6.2 as it is believed that this brings advantages through parallelization of different system components. However, the operation of both enclaves 6.1, 6.2 could be combined in a single enclave. Generally, enclaves are isolated from all software running on a system, including privileged OS. Enclave data is handled in plain-text only inside the CPU (i.e., in caches and registers) and when moved out of the CPU, e.g., into the memory (DRAM), encrypted and integrity protected.

For instance, a specific implementation of a enclave is Intel's Software Guard Extension (SGX), which is a set of CPU instructions for creating and managing isolated software components (for reference, see Intel. Intel Software Guard Extensions. https://software.intel.com/en-us/sgx). The OS, although untrusted, is responsible for creating and managing enclaves. However, all initialization actions of the OS are recorded securely by SGX inside the CPU. The initialization process creates a measurement that captures the enclave's code configuration and can be used for later verification by an external party using remote attestation. The sealing capability of SGX enables persistent secure storage of enclave data such that the data is only available to correctly created instances of the same enclave that originally saved it.

Referring again to FIGS. 1 and 2, the two enclaves 6 are a logging enclave 6.1 (denoted ‘E1’ in FIGS. 1 and 2) and a distribution enclave 6.2 (denoted ‘E2’), that are connected to each other through a secure channel. The two enclaves 6.1, 6.2 are responsible for different parts of the operation.

The node 2, which connects to the peer-to-peer network 3 of the blockchain and the webserver 5 hosting the state transparency log, as already mentioned above, also connects to the logging enclave 6.1. At a glance, the node 2 is configured to forward headers of received blocks as well as transaction hashes (with additional information such as, e.g., fee per byte) to the first enclave 6.1, which assembles the header template and maintains a log. Log entries are forwarded to blockchain node 2 that publishes the log on the website 4. The header template is forwarded to the second enclave 6.2 which creates work packets, distributes them to the miners 7, and counts the shares received from the miners 7 for reward distribution. If a full PoW (Proof-of-Work) is found, second enclave 6.2 forwards it to first enclave 6.1, which forwards it to N and includes it in the log.

In more detail, when the operator 1 starts the system, each of the two enclaves E1, E2 creates a keypair, which only exists during the enclaves lifetime, i.e. is not persistent over enclave restarts (to protect against rollback and forking attacks). The enclaves E1, E2 then perform mutual attestation (as shown at #1 in FIG. 2), during which they exchange keys, and establish a secure channel.

When miners 7 connect to the mining pool, they first perform attestation with the distribution enclave E2 (as shown at #2). As part of the attestation data, E2 sends the public keys of both E1 and E2. The public key of E1 is required to check the state transparency log, and the public key of E2 is used to establish a secure channel between the miner 7 and E2.

The blockchain node N performs attestation with the logging enclave E1 (as shown at #3) using, e.g., a recent block hash in the challenge (to let third parties check freshness) and publishes the attestation statement on the state transparency log website 4 (as shown at #4).

The blockchain node N is responsible for receiving incoming transactions and blocks (as shown at #5) and for checking the validity of these incoming transactions and blocks, i.e. blockchain node N performs the checks that a regular node would perform. It is safe to do this outside of an enclave 6, because if the operator 1 forwards invalid transactions or blocks, they show up in the log which would make such an attack detectable immediately. In addition, this would lead to reduced income, which is not in the interest of the mining pool operator 1, i.e., there is a negative incentive to do so.

After these validity checks, N forwards block headers of received blocks together with the hashes of transactions included in the blocks and information about new transactions (hereinafter briefly denoted transaction summaries) to the logging enclave E1 (as shown at #6). The required transaction information depends on the inclusion rules that the enclave 6 should adhere to, but in most cases most of the transaction data does not need to be forwarded. For example, if the inclusion rules say that transactions should be prioritized by their per-byte fee, node N needs to forward the transaction hash, size, and fee to the enclave 6. This allows to drastically reduce the memory footprint of the enclave 6, since only a few bytes of data need to be stored per transaction and the enclave 6 does not need to maintain the UTXO set. Hereinafter, the set of transaction summaries known to the enclave 6 will be referred to as the enclave's mempool.

Given only transaction summaries, the enclave 6 cannot determine if a received block contains a transaction that conflicts with one of the transactions in the enclave's 6 mempool. While this will only happen rarely, resolving this issue requires an option to remove a transaction summary from E1's mempool. According to an embodiment this may be realized by having the node N forward both of the conflicting transactions to the logging enclave E1, which allows E1 to check that they are in fact conflicting and the other transaction has been included in a received block.

The logging enclave E1 includes all received block and transaction information (as well as messages about conflicting transactions) in a state transparency log To do so, every such message received from the blockchain node N (the i-th message is denoted as mi) may be hashed together with the previous hash chain value hi−1 of the state transparency log. The new value hi=H(hi−1∥mi) may then be signed and sent back to node N (as shown at #7). N then publishes this signed value together with the actual blocks and transactions on a publicly accessible site 4, e.g. a website of a webserver 5, forming the state transparency log (as shown at #8).

Given E1's mempool, it creates block templates based on the rules defined in the enclave code, e.g., inclusion priority by per-byte fee. The logging enclave E1 then forwards this template to the distribution enclave E2 (as shown at #9), which creates work packets for each miner 7 based on it. E2 then sends these work packets to the miners 7 through the secure channels established during attestation with the distribution enclave E2 when connecting to the mining pool (as shown at #10). Once the miners 7 find partial PoWs (as shown at #11), the distribution enclave E2 receives shares from the miners 7, and sends them signed receipts (as shown at #12).

The received shares are then checked and counted by E2 and used to create payment transactions based on a used reward scheme, e.g. PPLNS. The payment transactions may be periodically forwarded to the blockchain node N and broadcast to the P2P network 3 (as shown at #18). Since the miners 7 receive signed receipts for the shares, they can be certain that the submitted share is counted and that they will therefore receive a fraction of the rewards proportional to their mining power. It should be noted that counting the submitted shares in the enclave 6.2 also ensures that no false shares can be submitted. For example, the mining pool operator 1 cannot artificially inflate the total number of shares to decrease the payout for the individual miners 7.

Once a full PoW, i.e., a valid block is found by a miner land sent to distribution enclave E2 (as shown at #13), E2 forwards it to logging enclave E1 (as shown at #14) which includes its hash in the state transparency log, and sends it to the blockchain node N (as shown at #15). The blockchain node N broadcasts the block to the P2P network 3 (as shown at #16) and updates the state transparency log on the website 5 (as shown at #17).

Miners 7 as well as third parties can regularly check the state transparency log to make sure that there are no discrepancies with the transactions and blocks broadcast in the peer-to-peer network 3, e.g., some blocks that have been broadcast in the network but do not show up in the log. If miners 7 notice such issues (e.g. if they are alerted by other parties), a majority will switch to other mining pools not showing dishonest behavior.

Clients who notice that their transactions, after broadcasting them in the network, do not show up in the publicly available transparency log, can send these transactions directly to the node N. If a transaction does still not show up in the state transparency log afterwards, they can be certain of censorship. If broadcast transactions frequently do not show up in the log, the log provides evidence of probable censorship that can convince other parties such as miners 7 (who can then switch to other mining pools).

Embodiments of the present invention make sure that blockchain participants can immediately detect if the mining pool is mining on a private branch, since all valid blocks that are forwarded to the logging enclave E1 show up in the state transparency log, i.e. if a valid block has propagated through the network, but does not show up in the state transparency log after some time, participants can alert miners 7. Assuming that a majority of miners 7 are honest, most miners 7 will leave mining pools showing such dishonest behavior, which makes it unlikely to succeed. As such, systems according to embodiments of the invention ensure correct branch selection, i.e. that the operator 1 lets miners 7 mine on top of the longest chain and that blocks found by the mining pool are not kept secret.

Furthermore, embodiments of the invention ensure censorship resistance, i.e. that every transaction received by the logging enclave E1 shows up in the state transparency log or, the other way round, that any censorship of arbitrary transactions can be prevented or detected. While the transparency log does not provide proof (in the mathematical sense) of censorship, it does provide evidence, since blockchain participants will notice if some transactions do not show up in the log after they have propagated through the network. If miners 7 notice systematic censorship, a majority of them will switch to other mining pools not showing such behavior.

Embodiments of the system according to the present invention also ensure that miners 7 will receive a payment for all shares except at most one. Once a miner 7 receives a signed receipt from the distribution enclave E2, he can be sure that the share will be counted for reward distribution. If he does not receive a receipt for a share, this share might have been blocked (i.e. he will not receive a reward for it), but he can immediately switch mining pools to ensure that no additional mining power is wasted. This guarantees that each miner 7 receives a share of the rewards proportional to his mining power if he mines with the mining pool for a significant amount of time, and at worst loses out on one share's worth of rewards.

The system according to the invention as described above has a very low overhead and mostly requires the same computation as current systems. The main overhead is securing the links to the miners 7 and providing the state transparency log, both of which is fast with modern cryptographic primitives. The changes from current systems (e.g. Stratum) to a system according to the invention in terms of miner effort is minimal. The main difference is that miners 7 need to perform attestation and communicate to distribution enclave E2 over a secure channel which can all be done automatically by the mining software. However, they do not need to be well connected to the P2P network 3 and do not need additional configuration to decide their own transaction selection, etc.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for operating a mining pool, the method comprising:
running, by a mining pool operator, a blockchain node and at least one enclave, wherein the blockchain node is connected to the enclave as well as to a blockchain peer-to-peer (P2P) network and to a publicly available site,
checking, by the blockchain node, validity of incoming blocks and transactions received from the blockchain P2P network and forwarding information on the received blocks and transactions to the at least one enclave,
creating, by the at least one enclave, a state transparency log and inserting block and transaction information received from the blockchain node into the state transparency log, and
signing, by the at least one enclave, the state transparency log and publishing the state transparency log at the publicly available site.

2. The method according to claim 1, wherein the block and transaction information inserted into the state transparency log comprises block headers of the received blocks, hashes of the transactions included in the received blocks, and additional information about the transactions included in the received blocks.

3. The method according to claim 2, wherein a determination as to which type of the additional information about the transactions in the received blocks is included into the state transparency log is made based on rules defined in the enclave code of the at least one enclave.

4. The method according to claim 1, the method further comprising:
sending, by the at least one enclave, work packets to the miners of the mining pool through a secure channel and receiving, in return, shares from the miners based upon partial PoWs being found,
checking, by the at least one enclave, the received shares and using the shares to create payment transactions for the miners based on a reward scheme.

5. The method according to claim 4, the method further comprising:
periodically receiving, by the blockchain node, the payment transactions created by the at least one enclave, and
broadcasting the received payment transactions to the blockchain P2P network.

6. The method according to claim 1, the method further comprising:
receiving, by the at least one enclave, a valid block from a miner,
including, by the at least one enclave, a hash of the valid block into the state transparency log and forwarding the valid block and the state transparency log to the blockchain node, and
broadcasting, by the blockchain node, the valid block to the blockchain P2P network and updating the state transparency log at the publicly available site.

7. The method according to claim 1, the method further comprising:
performing, by the mining pool operator, attestation with the at least one enclave and publishing the attestation statement on the publicly available site.

8. The method according to claim 1, wherein a private key used by the at least one enclave for signing the state transparency log is newly created at each restart of the enclave.

9. The method according to claim 1, wherein the mining pool operator runs two enclaves, wherein the two enclaves perform mutual attestation for each other during which the two enclaves exchange keys, and establish a secure channel between each other.

10. The method according to claim 9, wherein a first one of the two enclaves interacts with the blockchain node, and wherein a second one of the two enclaves interacts with miners connecting to the mining pool.

11. A mining pool operation system run by a mining pool operator, the system comprising:
a blockchain node, and
at least one enclave, wherein the blockchain node is connected to the enclave as well as to a blockchain P2P network and to a publicly available site,
wherein the blockchain node is configured to check the validity of incoming blocks and transactions received from the blockchain P2P network and to forward information on the received blocks and transactions to the at least one enclave,
wherein the at least one enclave is configured to create a state transparency log, to insert the block and transaction information received from the blockchain node into the state transparency log, and to sign the state transparency log, and
wherein the blockchain node is further configured to publish the signed state transparency log at the publicly available site.

12. The system according to claim 11, wherein the at least one enclave is configured to
send work packets to the miners through a secure channel,
receive in return shares from the miners once partial PoWs are found,
check the received shares and use the received shares to create payment transactions for the miners based on a reward scheme.

13. The system according to claim 12, wherein the blockchain node is configured to
periodically receive the payment transactions created by the at least one enclave, and
broadcast the received payment transactions to the blockchain P2P network.

14. The system according to claim 11, wherein the at least one enclave is configured to receive a valid block from a miner, to include a hash of the valid block into the state transparency log and to forward the valid block and the state transparency log to the blockchain node, and
wherein the blockchain node is configured to broadcast the valid block to the blockchain P2P network and update the state transparency log at the publicly available site.

15. The system according to claim 11, the system comprising:
a first enclave and a second enclave, wherein the two enclaves are configured to perform mutual attestation for each other during which the two enclaves exchange keys, and establish a secure channel between each other, and
wherein the first enclave of the two enclaves is configured to interact with the blockchain node, and wherein a second enclave of the two enclaves is configured to interact with miners connecting to the mining pool.

16. The method according to claim 3, wherein the rules comprise inclusion rules.
